(19) United States
(12) Patent Application Publication
(10) Pub. No.: US 2002/0069242 A1
(43) Pub. Date: Jun. 6, 2002

(54) Systems and methods providing functional magnetic resonance imaging data analysis services

(76) Inventor: Gregory S. Berns, Atlanta, GA (US)

Correspondence Address: Adam E. Crall, THOMAS, KAYDEN, HORSTEMEYER & RISLEY, L.L.P., Suite 1750, 100 Galleria Parkway, N.W., Atlanta, GA, 30339-5948, US

(21) Appl. No.: 09/732,219

(22) Filed: Dec. 6, 2000

Related U.S. Application Data
(60) Provisional application No. 60/168,715, filed on Dec. 6, 1999.

(51) Int. Cl. G06F 15/16

(52) U.S. Cl. 709/203

(57) ABSTRACT

Systems and method for providing functional magnetic resonance imaging (fMRI) data analysis and comparison services are provided. The system comprises an interface, a processing engine, an fMRI comparison engine, a searchable database, and a billing functionality. The interface may be adapted to receive from a client via a communications network a client data set containing information related to a functional magnetic resonance image. The processing engine may be programmed to identify a plurality of spatially independent components related to the client data set by applying a blind source separation algorithm to the client data set. The searchable database may include information related to (i) a plurality of sets of independent components corresponding to a plurality of functional magnetic resonance image data sets and (ii) a set of fundamental independent components comprising common components which exist in a scientifically-significant portion of the plurality of sets of independent components. The fMRI comparison engine may be programmed to compare the plurality of independent components related to the client data set to the set of fundamental independent components in the database. The interface may be coupled to the comparison engine and adapted to deliver to the client information based on the comparison via the communications network. The billing functionality may be coupled to the interface and adapted to charge the client for delivering the information based on the comparison.

### CROSS-REFERENCE TO RELATED APPLICATION

This application claims priority to U.S. Provisional Application No. 60/168,715 entitled “A System for Cataloguing Brain Activation Signatures With Functional Magnetic Resonance Imaging and Dimensional Reduction” and filed Dec. 6, 1999, which is herein incorporated by reference in its entirety.

### FIELD OF THE INVENTION

The present invention relates generally to functional magnetic resonance imaging (fMRI) and independent components analysis methods, and more particularly, to systems and methods for providing fMRI data analysis services.

### BACKGROUND OF THE INVENTION

In recent years, functional magnetic resonance imaging (fMRI) methods have increasingly become the focus of research and development. As the name suggests, fMRI uses conventional magnetic resonance imaging (MRI) technology to develop images of a brain as an individual performs a cognitive task. The resulting images illustrate the regions of the brain related to performing the cognitive task. Methods of performing fMRI are based on the physical principles of magnetic resonance, which determine fMRI signal characteristics, and through which it is possible to form fMRI images.

In fMRI, an individual's head is first placed into a strong magnetic field. In response to the magnetic field, various atomic nuclei, particularly the proton nucleus of atoms, align themselves with this field and reach a magnetic equilibrium. Then, the proton nuclei precess about the applied field at a characteristic frequency, but at a random phase with respect to one another. A brief radio frequency (RF) electromagnetic pulse at the resonant frequency is then applied to the brain, which excites the protons and introduces a transient phase coherence to the nuclear magnetization that can, in turn, be detected as a radio signal by a magnetic resonance (MR) scanner and formed into an image.

The resulting signals vary in strength where hydrogen is in greater or lesser concentrations in the brain, and are processed through a computer to produce an image. Regions of the brain related to performing the cognitive task can be determined because the increase in neuronal activity results in more oxygenated blood in those regions. Oxygenated blood has different magnetic properties than blood in which the hemoglobin has been stripped of its oxygen. Therefore, the relative concentrations of oxygenated and deoxygenated blood in the brain can be measured. Furthermore, by making small changes in the magnetic field it is possible to determine where response signals originate spatially in the brain.

Conventional fMRI methods employ a subtractive approach to brain imaging. Because the MR scanner can only measure the differential change in cerebral blood flow correlated with underlying neuronal activity, conventional subtractive approaches for fMRI involve subjects performing two different cognitive processes. A scan is taken while a subject performs one cognitive task followed by another. In theory, by subtracting the scan corresponding to the second task from the scan corresponding to the first task, it is possible to determine the brain regions involved in performing the second task. For example, the first task may involve retention of a ten-digit telephone number and the second task may involve retention of a three-digit number. It is common to perform more complex variations of this approach, such as by performing multiple cognitive tasks or by continuously varying tasks, but all such methods involve selecting a control task to see how brain activity changes between two tasks.

The subtractive approach suffers from several disadvantages. First, this approach requires very careful selection of the two cognitive tasks. Ideally, the cognitive tasks need to have some similarity. For example, comparing a scan taken while watching a portion of a movie to a scan taken while doing arithmetic would not provide any meaningful correlation between the parts of the brain which changed from one task to the other because the tasks do not have anything in common.

The subtractive approach also has limited effectiveness because it is a hypothesis-driven method. This means that the study must be designed to test a given hypothesis. In other words, some knowledge of the brain and cognitive processes must be known or hypothesized and the tasks are selected to test this hypothesis. This type of hypothesis-driven method requires very detailed experiments.

Some of these limitations were addressed when, in 1997, it was first suggested to apply independent components analysis (ICA) or blind sources signal processing (BSS) methods to fMRI. In many signal processing applications, the sample signals provided by the sensors are mixtures of many unknown sources. The “separation of sources” problem is to extract the original unknown signals from the known mixture. Generally, the signal sources, as well as their mixture characteristics are unknown. Without knowledge of the signal sources other than the general statistical assumption of source independence, this signal processing problem is known as the “blind source separation problem.” The separation is “blind” because nothing is known about the statistics of the independent source signals and nothing is known about the mixing process.

One common example of the blind source separation problem is the well-known “cocktail party” problem, which refers to a situation where the unknown (source) signals are sounds generated in a room and the known (sensor) signals are the outputs of several microphones. Each of the source signals is delayed and attenuated in some time-varying manner during transmission from source to microphone, where it is then mixed with other independently delayed and attenuated source signals, including multipath versions of itself (reverberation), which are delayed versions arriving from different directions.

In the context of fMRI, the blind source separation problem refers to the fact that the fMRI data sets measured by the MR scanner (known signals) may be a mixture of a set of independent components (unknown signals). When using BSS algorithms in fMRI methods, the designer of the fMRI research does not need to know anything about the system. The BSS algorithm assumes that the fMRI data sets are composed of an unknown mixture of independent components.

In recent years, researchers and academics have begun using BSS algorithms in fMRI to identify spatially independent components associated with an fMRI data set. Some have theorized that using BSS algorithms to determine independent components for a large number of fMRI data sets may yield a set of common independent components, which exist in a significant portion of the representative independent components. For example, there may be a finite set of independent components from which all fMRI data sets are composed.

There are two common approaches being employed for searching for a set of fundamental independent components for fMRI data sets. The first approach involves academic researchers performing fMRI studies on a small number of subjects (approximately 10-20). Although these studies do identify independent components for each subject in the small group based on a particular type of cognitive task, they are very slow and tedious. Furthermore, because there are only a small number of subjects, there is little chance of identifying a relevant set of common independent components.

Another approach is to create a large national database where fMRI data is collected from a large number of the academic researchers such as those referred to in the first approach. In this approach, a large amount of data is collected. However, the data is not stored in the database in such a way to enable identification of a set of independent components. For example, the information stored in the national database relates to a “raw data set,” which has not been dimensionally reduced using a singular value decomposition algorithm. Thus, each fMRI data set is much too large to provide meaningful comparison.

Thus, an unaddressed need exists in the industry to address these aforementioned deficiencies and inadequacies by providing a method of developing an fMRI database large enough to identify a set of fundamental components in an fMRI data set.

### SUMMARY OF THE INVENTION

The present invention addresses the problems discussed above in developing a catalogue of sets of independent components associated with an fMRI data set from which to identify a common set of independent components by providing systems and methods for providing fMRI data analysis and comparison services.

The systems and methods of the present invention relate to three principal aspects: (1) providing fMRI data analysis services and leveraging the provisioning of these services to obtain large numbers of fMRI data sets; (2) using the fMRI data sets to develop an fMRI database containing sets of independent components associated with the fMRI data sets and a set of common independent components which exist in a scientifically-significant portion of the fMRI data sets; and (3) leveraging the database by providing fMRI data comparison services.

Briefly described, a system related to the first principal aspect of the present invention for providing fMRI data analysis services comprises (1) a means for receiving from a client via a communications network a data set containing information related to an fMRI image of an individual's brain, (2) a means for identifying a plurality of spatially independent components related to the data set by applying a blind source separation algorithm to the data set, and (3) a means for delivering to the client via the communications network information related to the plurality of independent components of the data set. The system may also include a means for reducing the dimensionality of the data set by applying a singular value decomposition algorithm to the data set prior to identifying spatially independent components of the data set; a means for charging the client for delivering the independent components of the data set; a means for storing the plurality of independent components; a means for receiving a request from the client via the communications network to compare the plurality of independent components to information related to a plurality of sets of other independent components, each set of other independent components corresponding to another data set related to a distinct functional magnetic resonance image; a means for comparing the plurality of independent components to the plurality of sets of independent components in the database; a means for delivering to the client via the communications network information based on the comparison; and a means for charging the client for delivering the information based on the comparison.

A system related to the second principal aspect of the present invention for developing an fMRI database containing information related to a plurality of fMRI data sets comprises (1) a means for offering fMRI data analysis services to clients, (2) a means for receiving a plurality of client data sets from a plurality of clients via the communications network, and (3) a means for providing the functional magnetic resonance imaging data analysis services to the plurality of clients. The fMRI data analysis services may include: enabling a client to transmit via a communications network a client data set, the client data set containing information related to a functional magnetic resonance image; reducing the dimensionality of the client data set by applying a singular value decomposition algorithm to the client data set; identifying a plurality of spatially independent components related to the client data set by applying a blind source separation algorithm to the data set; and delivering to the client via the communications network information related to the plurality of independent components related to the client data set. The system may also include a means for storing the plurality of sets of independent components corresponding to the plurality of clients in the database; a means for comparing each of the plurality of sets of independent components to the other sets of independent components; a means for identifying common components which exist in a scientifically-significant portion of the plurality of sets of independent components; and a means for charging the plurality of clients for the services.

A system related to the third principal aspect of the present invention for providing functional magnetic resonance imaging data comparison services comprises (1) a means for receiving from a client via a communications network a client data set containing information related to a functional magnetic resonance image, (2) a means for reducing the dimensionality of the client data set by applying a singular value decomposition algorithm to the client data set, (3) a means for identifying a plurality of spatially independent components related to the client data set by applying a blind source separation algorithm to the client data set, and (4) a means for receiving from the client a request to compare the plurality of independent components to a set of fundamental independent components in a database, the set of fundamental independent components comprising common components which exist in a scientifically-significant portion of a plurality of sets of independent components corresponding to a plurality of functional magnetic resonance image data sets contained in the database. The system may also include a means for comparing the plurality of independent components related to the client data set to the set of fundamental independent components in the database; a means for delivering to the client information based on the comparison via the communications network; and a means for charging the client for delivering the information based on the comparison. In another embodiment of this system, the set of fundamental independent components in the database is modified based on the plurality of independent components related to the client data set.

The present invention can also be viewed as providing one or more methods for providing fMRI data analysis services. Briefly, one such method related to the first principal aspect of the present invention involves (1) receiving from a client via a communications network a data set containing information related to a functional magnetic resonance image of an individual's brain, (2) reducing the dimensionality of the data set by applying a singular value decomposition algorithm to the data set, (3) identifying a plurality of spatially independent components related to the data set by applying a blind source separation algorithm to the data set, (4) delivering to the client via the communications network information related to the plurality of independent components of the data set, (5) charging the client for delivering the independent components of the data set, (6) storing the plurality of independent components in a database containing information related to a plurality of sets of other independent components, each set of other independent components corresponding to another data set related to a distinct functional magnetic resonance image of another individual's brain, (7) receiving a request from the client via the communications network to compare the plurality of independent components to the plurality of sets of other independent components in the database, (8) comparing the plurality of independent components to the plurality of sets of independent components in the database, (9) delivering to the client via the communications network information based on the comparison, and (10) charging the client for delivering the information based on the comparison.

Briefly, a method related to the second principal aspect of the present invention involves (1) offering functional magnetic resonance imaging data analysis services to clients, (2) receiving a plurality of client data sets from a plurality of clients via the communications network, and (3) providing the functional magnetic resonance imaging data analysis services to the plurality of clients. The fMRI services may include: enabling a client to transmit via a communications network a client data set, the client data set containing information related to a functional magnetic resonance image; identifying a plurality of spatially independent components related to the client data set by applying a blind source separation algorithm to the data set; and delivering to the client via the communications network information related to the plurality of independent components related to the client data set. The method may also involve storing the plurality of sets of independent components corresponding to the plurality of clients in the database; comparing each of the plurality of sets of independent components to the other sets of independent components; identifying common components which exist in a scientifically-significant portion of the plurality of sets of independent components; and charging the plurality of clients for the services.

Briefly, a method related to the third principal aspect of the present invention for providing functional magnetic resonance imaging data comparison services involves (1) receiving from a client via a communications network a client data set containing information related to a functional magnetic resonance image, (2) reducing the dimensionality of the client data set by applying a singular value decomposition algorithm to the client data set, (3) identifying a plurality of spatially independent components related to the client data set by applying a blind source separation algorithm to the client data set, (4) receiving from the client a request to compare the plurality of independent components to a set of fundamental independent components in a database, the set of fundamental independent components comprising common components which exist in a scientifically-significant portion of a plurality of sets of independent components corresponding to a plurality of functional magnetic resonance image data sets contained in the database, (5) comparing the plurality of independent components related to the client data set to the set of fundamental independent components in the database, (6) charging the client for delivering the information based on the comparison, and (7) modifying the set of fundamental independent components in the database based on the plurality of independent components related to the client data set.

Accordingly, systems and methods of the present invention encourage entities, such as, for example, hospitals, academic researchers, sole medical practitioners, and fMRI database owners, desiring to perform fMRI data analysis to purchase such services. By providing the fMRI data analysis services, systems and methods of the present invention, for the first time, create a market space for providing fMRI comparison services to entities, such as, for example, businesses and government agencies, desiring to compare fMRI data sets corresponding to a particular person to a statistically-relevant set of fundamental common components associated with a large collection of fMRI data sets.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment of an fMRI service provider system according to the present invention.

FIG. 2 is a flow chart illustrating the architecture, functionality, and the operation of the fMRI service provider system of FIG. 1 for providing fMRI data analysis services according to the systems and methods of the present invention.

FIG. 3 is a flow chart illustrating the architecture, functionality, and the operation of the fMRI service provider system of FIG. 1 for developing an fMRI database according to the systems and methods of the present invention.

FIG. 4 is a flow chart illustrating the architecture, functionality, and the operation of the fMRI service provider system of FIG. 1 for providing fMRI data comparison services according to the systems and methods of the present invention.

### DETAILED DESCRIPTION OF THE PREFERRED EMBODIMENT

Having summarized the invention above, reference is now made in detail to the description of the invention as illustrated in the drawings. While the invention will be described in connection with these drawings, there is no intent to limit it to the embodiment or embodiments disclosed. On the contrary, the intent is to cover all alternatives, modifications and equivalents included within the spirit and scope of the invention as defined by the appended claims.

I. System Architecture

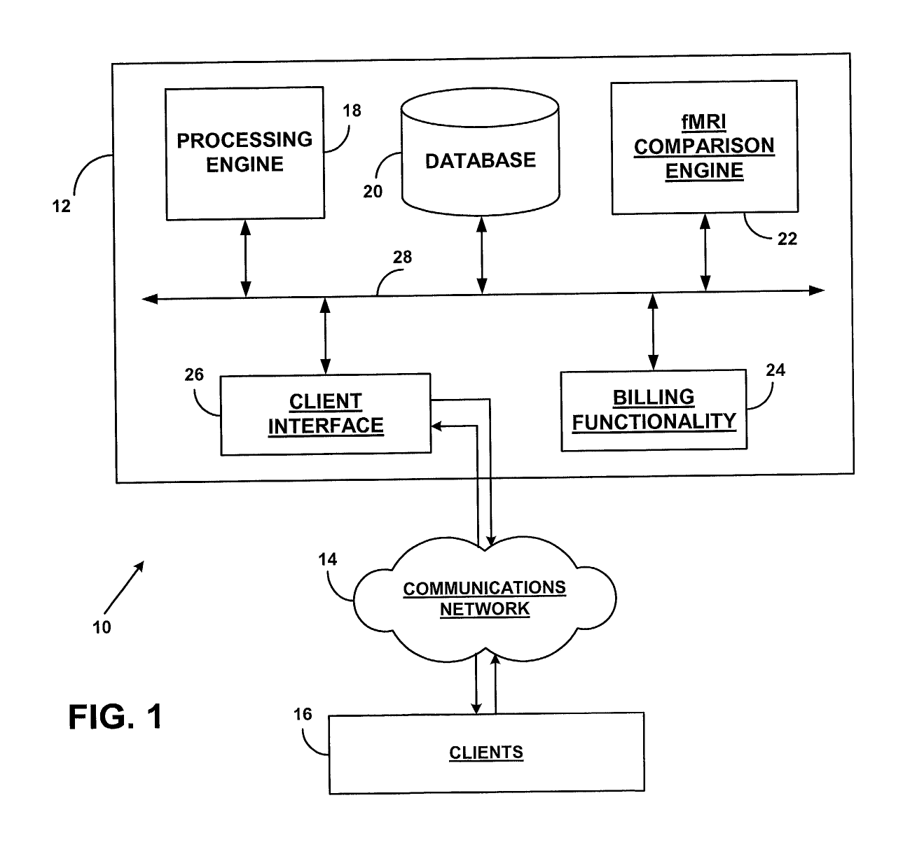

FIG. 1 illustrates a preferred embodiment of an fMRI service provider system 10 for implementing the systems and methods of the present invention. fMRI service provider system 10 includes a platform 12, a communications network 14, and clients 16. Clients 16 may access platform 12 via communications network 14.

Communications network 14 may be any public or private packet-switched or other data network, circuit switched network such as the public switched telephone network, wireless network, or any other desired communications infrastructure. In the preferred embodiment, communications network 14 is the Internet.

Clients 16 may be hospitals, academic researchers, fMRI database owners, sole medical practitioners, businesses, government entities, or any other entity desiring to purchase services provided by platform 12.

In a preferred embodiment, platform 12 comprises processing engine 18, database 20, fMRI comparison engine 22, billing functionality 24, client interface 26, and local interface 28. Processing engine 18, database 20, fMRI comparison engine 22, billing functionality 24, and client interface 26 are coupled to each other via local interface 28.

Client interface 26 is configured to receive communications from and deliver communications to clients 26 via communications network 14. Interface 26 may be implemented using any known interfacing technology for communicating between platform 12 and clients 26, which necessarily depends on the particular characteristics of communications network 14. Therefore, depending on the particular characteristics of communications network 14, interface 26 may be configured to communicate with a public or private packet-switched or other data network, a circuit switched network such as the public switched telephone network, or a wireless network. In the preferred embodiment, client interface 26 is a web server.

Processing engine 18 may be any computer-based system, processor-containing system, or other similar system capable of being programmed to perform blind source separation algorithms, such as, for example, the neural network system disclosed in U.S. Pat. No. 5,706,402 to Bell, which is hereby incorporated by reference in its entirety, and the blind source separation algorithm disclosed by AJ Bell and TJ Sejnowski (“An information-maximization approach to blind separation and blind deconvolution” Neural Computation 7:1129-1159 (1995)), which is hereby incorporated by reference in its entirety, and single value decomposition algorithms, such as, for example, the single value decomposition algorithm disclosed in “Adaptive Filter Theory” by Simon Haykin (Third Edition, Prentice-Hall (NJ), (1996)), which is hereby incorporated by reference in its entirety.

It should be known to one of ordinary skill in the art that various other blind source separation algorithms and single value decomposition algorithms exist. Therefore, the present invention is not intended to be limited to a particular type of algorithm.

Comparison engine 22 may be any computer-based system, processor-containing system, or other similar system capable of being programmed to compare sets of independent components associated with fMRI data sets.

Billing functionality 24 may be any computer-based system, processor-containing system, or other similar system capable of being programmed charge clients 16 for services performed by platform 12.

II. Overview of Services Provided

As will be described in detail below, platform 12 may be configured to provide fMRI data analysis services to clients 16. In accordance with the systems and methods of the present invention, platform 12 has three principal aspects.

First, platform 12 may be configured to provide fMRI data analysis services to clients 16. In general, these services enable clients 16 to perform complex analysis of fMRI data sets without incurring the necessary expense associated with establishing systems for performing such functions, which may be an obstacle to many clients 16. Instead, clients 16 may purchase these services as they are needed. The provisioning of these services are leveraged to obtain large numbers of fMRI data sets from clients 16.

Second, the fMRI data sets acquired from clients 16 are used to develop an fMRI database 20 containing sets of independent components associated with the fMRI data sets and a set of common independent components which exist in a scientifically-significant portion of the fMRI data sets. As described above, because of the complexity of the brain, a large number of fMRI data sets are required to identify similarities or correlations between the independent components in a collection of fMRI data sets. Providing these services to clients 16 enables development of database 20.

Thirdly, platform 12 leverages database 20 by providing additional services to clients. In general, these additional services enable clients 16 to request that an uploaded fMRI data set be compared against database 20. Platform 12 may receive an fMRI data set from a client 16 and compare independent components associated with the data set against a set of fundamental independent components in database 20.

In this manner, as more and more fMRI data sets are received by clients 16 and input into database 20, comparison engine 22 may be used to identify more and more powerful similarities or correlations between the sets of independent components in database 20, thereby increasing the statistical significance of the set of fundamental independent components. As the statistical significance of the set of fundamental independent components increases, the complexity and value of the services offered to clients 16 may also be increased, which directly translates into more revenue generated by platform 12. Thus, platform 12 for the first time creates incentives for entities, such as, for example, hospitals, academic researchers, sole medical practitioners, and fMRI database owners, desiring to perform fMRI data analysis to purchase such services. In addition, platform 12 also enables for the first time the provisioning of services such as the comparison of an individual fMRI data set corresponding to a particular person to a statistically-relevant set of fundamental common components associated with a large collection of fMRI data sets.

III. Operation of System

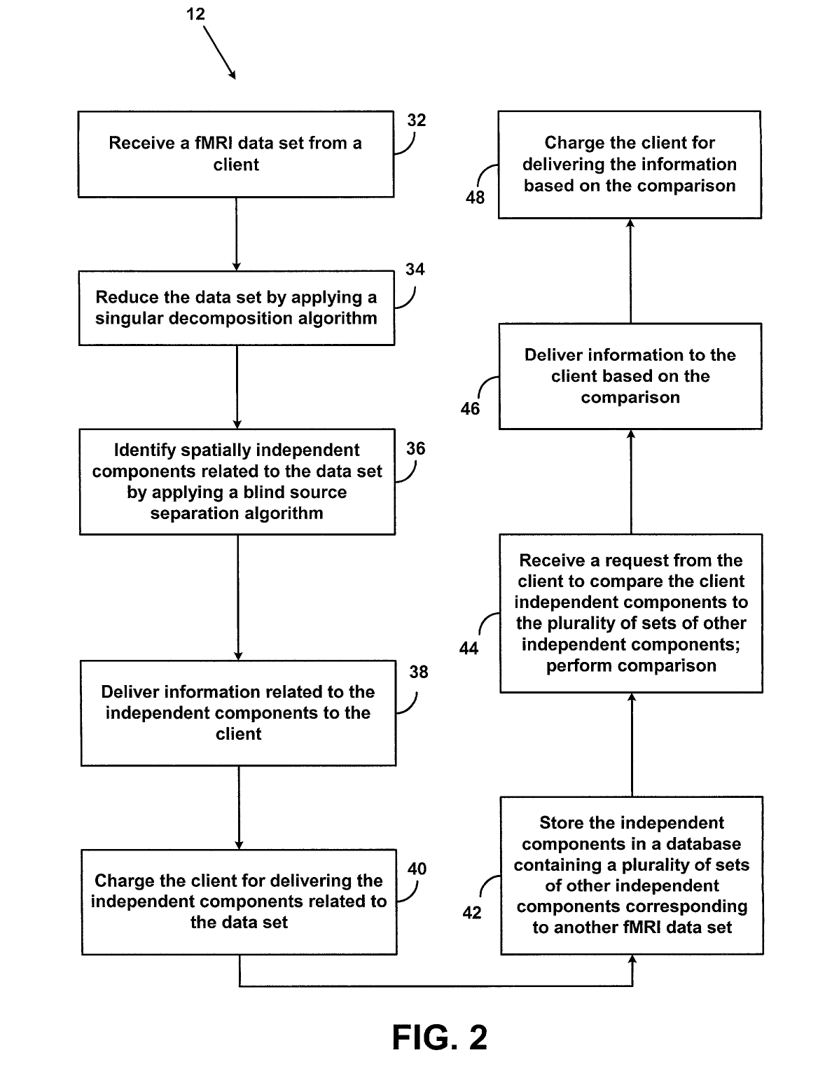

Referring to FIGS. 2-4, the architecture, functionality, and operation of platform 12 will be described. As stated above, platform 12 has three principal aspects, each of which is described below.

A. Analysis of fMRI Data from Clients

FIG. 2 is a flow chart illustrating the architecture, functionality, and operation of platform 12 for providing fMRI data analysis services to clients 16. At block 32, an fMRI data set is received from a client 16. At block 34, the dimensionality of the fMRI data set is reduced by applying a singular value decomposition algorithm. At block 36, spatially independent components related to the fMRI data set are identified by applying a blind source separation algorithm. At block 38, information related to the independent components are provided to client 16. At block 40, client 16 is charged for receiving the independent components. At block 42, the independent components corresponding to the fMRI data set are stored. At block 44, a request is received from client 16 to compare the independent components related to the client fMRI data against other independent components which are stored. At block 46, information is delivered to the client 16 based on the results of the comparison. At block 48, the client 16 is charged for having the information delivered.

It should be known by those of ordinary skill in the art that any known or future algorithm for dimensionally reducing the fMRI data set is suitable and intended to be incorporated within the present invention. Similarly, any known or future blind source separation algorithm is suitable and intended to be incorporated within the present invention.

Referring again to FIG. 1, in the preferred embodiment, platform 12 receives an fMRI data set from a client 16 via communications network 14 at client interface 26. Processing engine 18 receives the fMRI data set and, based on logic by which it is programmed, reduces the dimensionality of the fMRI data set by applying a singular value decomposition algorithm. Processing engine 18 also identifies, based on further logic by which it is programmed, spatially independent components related to the fMRI data set by applying a blind source separation algorithm. Platform 12 delivers information related to the independent components identified by processing engine 18 to client 16 via client interface 26. Billing functionality 24, in cooperation with client interface 26, charges client 16 for receiving the independent components. The independent components corresponding to the fMRI data set are stored in database 20.

Platform 12 may also receive a request via interface 26 from client 16 to compare the independent components related to the fMRI data against other independent components associated with other fMRI data sets which are stored in database 20. After comparison engine 22 compares the independent components related to the fMRI data set associated with the client 16 against the independent components stored in database 20, platform 12 may deliver to the client 16 via interface 26 information based on the results of the comparison. Billing functionality 24, in cooperation with client interface 26, may also be configured to charge client 16 for receiving the information based on the results of the comparison performed by comparison engine 22.

B. Developing fMRI Database

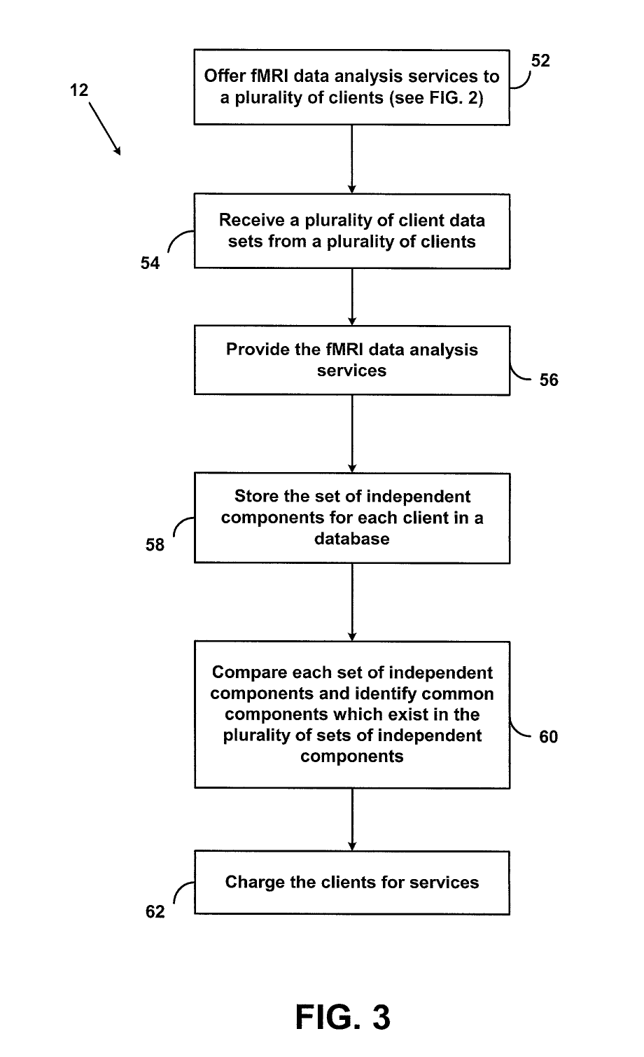

FIG. 3 is a flow chart illustrating the architecture, functionality, and operation of platform 12 for developing database 20. At block 52, fMRI data analysis services, such as, for example, the services described with respect to method 30 are offered to clients 16. At block 54, multiple fMRI data sets are received from clients 16. At block 56, the fMRI data analysis services are provided to clients 16. At block 58, the independent components, which are identified during the provisioning of the services, are stored. At block 60, each set of independent components related to clients 16 are compared and a set of common components are identified. At block 62, clients 16 are charged for the fMRI data analysis services.

Referring again to FIG. 1, in the preferred embodiment, platform 12 is configured for the provisioning of fMRI data analysis services, such as those described above, to multiple clients 16. The fMRI data set and the corresponding set of independent components identified by processing engine 18 may be stored in database 20. Based on logic by which it is programmed, comparison engine 22 may be configured to compare each set of independent components related to clients 16 and yield a set of common independent components, which are stored in database 20.

C. Comparison of Client fMRI Data Set to Database

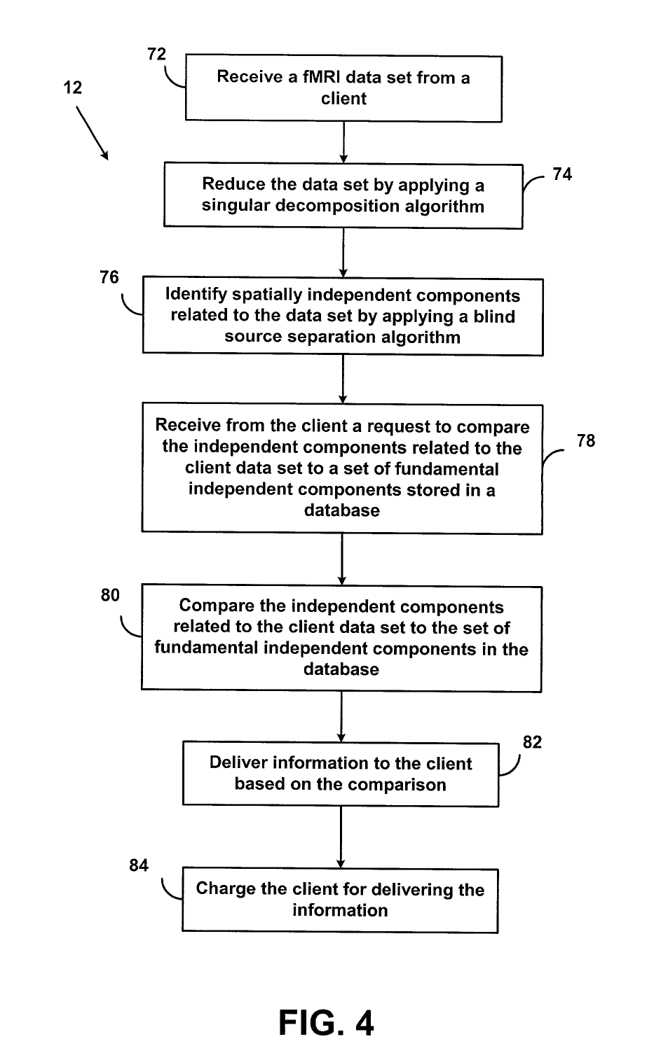

FIG. 4 is a flow chart illustrating the architecture, functionality, and operation of platform 12 for providing fMRI data comparison services to clients 16. At block 72, an fMRI data set is received from a client 16. At block 74, the data set is dimensionally reduced based on a singular value decomposition algorithm. At block 76, spatially independent components associated with the reduced data set are identified based on a blind source separation algorithm. At block 78, a request is received from the client 16 to compare independent components associated with the client data set to a set of fundamental independent components stored in the database 20. At block 80, the independent components associated with the client data set are compared to the set of fundamental components. At block 82, information is delivered to the client 16 based on the results of the comparison. At block 84, the client is charged for receiving the information.

Referring again to FIG. 1, in the preferred embodiment, platform 12 may be further configured for the provisioning of fMRI data comparison services. For example, platform 12 receives an fMRI data set from a client 16 via client interface 26. Processing engine 18 receives the fMRI data set and, based on logic by which it is programmed, reduces the dimensionality of the fMRI data set by applying a singular value decomposition algorithm. Processing engine 18 also identifies, based on further logic by which it is programmed, spatially independent components related to the fMRI data set by applying a blind source separation algorithm. Platform 12 also receives a request from the client 16 via interface 26 to compare the independent components associated with the client fMRI data set to a set of fundamental independent components stored in database 20. Comparison engine 22 compares the independent components associated with the client data set to the set of fundamental components in database 20. Platform 12 delivers information to the client 16 based on the results of the comparison performed by comparison engine 22. Billing functionality 24 may be further configured to charge client 16 for receiving the information via interface 26.

Platform 12, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing functional magnetic resonance imaging data analysis services, comprising:
receiving from a client via a communications network a data set containing information related to a functional magnetic resonance image of an individual's brain;
identifying a plurality of spatially independent components related to the data set by applying a blind source separation algorithm to the data set; and
delivering to the client via a communications network information related to the plurality of independent components of the data set.

2. The method of claim 1, further comprising reducing the dimensionality of the data set by applying a singular value decomposition algorithm to the data set prior to identifying spatially independent components of the data set.

3. The method of claim 1, further comprising charging the client for delivering the independent components of the data set.

4. The method of claim 1, wherein the receiving from a client and the delivering to the client is via the Internet and the client views the information related to the plurality of independent components of the data set with a web browser.

5. The method of claim 1, further comprising storing the plurality of independent components in a database containing information related to a plurality of sets of other independent components, each set of other independent components corresponding to another data set related to a distinct functional magnetic resonance image of another individual's brain.

6. The method of claim 1, further comprising receiving a request from the client via the communications network to compare the plurality of independent components to the plurality of sets of other independent components in the database.

7. The method of claim 6, further comprising (i) comparing the plurality of independent components to the plurality of sets of independent components in the database and (ii) delivering to the client via the communications network information based on the comparison.

8. The method of claim 7, further comprising charging the client for delivering the information based on the comparison.

9. A method of developing a functional magnetic resonance image database containing information related to a plurality of data sets, each of the plurality of data sets corresponding to a different functional magnetic resonance image, comprising:
offering functional magnetic resonance imaging data analysis services, the services comprising (i) enabling a client to transmit via a communications network a client data set, the client data set containing information related to a functional magnetic resonance image, (ii) identifying a plurality of spatially independent components related to the client data set by applying a blind source separation algorithm to the data set, and (iii) delivering to the client via the communications network information related to the plurality of independent components related to the client data set;
receiving a plurality of client data sets from a plurality of clients via the communications network; and
providing the functional magnetic resonance imaging data analysis services to the plurality of clients.

10. The method of claim 9, further comprising storing the plurality of sets of independent components corresponding to the plurality of clients in the database.

11. The method of claim 10, further comprising comparing each of the plurality of sets of independent components to the other of the plurality of sets of independent components.

12. The method of claim 11, further comprising identifying common components which exist in a scientifically-significant portion of the plurality of sets of independent components.

13. The method of claim 9, wherein the services further comprise reducing the dimensionality of the client data set by applying a singular value decomposition algorithm to the client data set prior to identifying a plurality of spatially independent components related to the client data set.

14. The method of claim 9, further comprising charging the plurality of clients for the services.

15. The method of claim 9, wherein the communications network is the Internet and the plurality of clients view the information related to the plurality of independent components of the data set with a web browser.

16. A method of providing functional magnetic resonance imaging comparison services, comprising:
receiving from a client via a communications network a client data set containing information related to a functional magnetic resonance image;
identifying a plurality of spatially independent components related to the client data set by applying a blind source separation algorithm to the client data set; and
receiving from the client a request to compare the plurality of independent components to a set of fundamental independent components in a database, the set of fundamental independent components comprising common components which exist in a scientifically-significant portion of a plurality of sets of independent components corresponding to a plurality of functional magnetic resonance image data sets contained in the database.

17. The method of claim 16, further comprising comparing the plurality of independent components related to the client data set to the set of fundamental independent components in the database.

18. The method of claim 17, further comprising delivering to the client information based on the comparison via the communications network.

19. The method of claim 16, further comprising reducing the dimensionality of the client data set by applying a singular value decomposition algorithm to the client data set prior to identifying spatially independent components of the client data set.

20. The method of claim 18, further comprising charging the client for delivering the information based on the comparison.

21. The method of claim 18, wherein the receiving from a client and the delivering to the client is via the Internet and the client views the information with a web browser.

22. The method of claim 16, further comprising modifying the set of fundamental independent components in the database based on the plurality of independent components related to the client data set.

23. A system for providing functional magnetic resonance imaging data analysis services, comprising:
a means for receiving from a client via a communications network a data set containing information related to a functional magnetic resonance image of an individual's brain;
a means for identifying a plurality of spatially independent components related to the data set by applying a blind source separation algorithm to the data set; and
a means for delivering to the client via a communications network information related to the plurality of independent components of the data set.

24. The system of claim 23, further comprising a means for reducing the dimensionality of the data set by applying a singular value decomposition algorithm to the data set prior to identifying spatially independent components of the data set.

25. The system of claim 23, further comprising a means for charging the client for delivering the information related to the plurality of independent components related to the data set.

26. The system of claim 23, wherein the communications network is the Internet and the client views the information related to the plurality of independent components related to the data set with a web browser.

27. The system of claim 23, further comprising a means for storing the plurality of independent components.

28. The system of claim 23, further comprising a means for receiving a request from the client via the communications network to compare the plurality of independent components to information related to a plurality of sets of other independent components, each set of other independent components corresponding to another data set related to a distinct functional magnetic resonance image.

29. The system of claim 28, further comprising a means for comparing the plurality of independent components to the plurality of sets of independent components in the database and a means for delivering to the client via the communications network information based on the comparison.

30. The system of claim 29, further comprising a means for charging the client for delivering the information based on the comparison.

31. A system for developing a functional magnetic resonance image database containing information related to a plurality of data sets, each of the plurality of data sets corresponding to a different functional magnetic resonance image, comprising:
a means for offering functional magnetic resonance imaging data analysis services, the services comprising (i) enabling a client to transmit via a communications network a client data set, the client data set containing information related to a functional magnetic resonance image, (ii) identifying a plurality of spatially independent components related to the client data set by applying a blind source separation algorithm to the data set, and (iii) delivering to the client via the communications network information related to the plurality of independent components related to the client data set;
a means for receiving a plurality of client data sets from a plurality of clients via the communications network; and
a means for providing the functional magnetic resonance imaging data analysis services to the plurality of clients.

32. The system of claim 31, further comprising a means for storing the plurality of sets of independent components corresponding to the plurality of clients in the database.

33. The system of claim 32, further comprising a means for comparing each of the plurality of sets of independent components to the other of the plurality of sets of independent components.

34. The system of claim 33, further comprising a means for identifying common components which exist in a scientifically-significant portion of the plurality of sets of independent components.

35. The system of claim 31, wherein the services further comprise reducing the dimensionality of the client data set by applying a singular value decomposition algorithm to the client data set prior to identifying a plurality of spatially independent components related to the client data set.

36. The system of claim 31, further comprising a means for charging the plurality of clients for the services.

37. The system of claim 31, wherein the communications network is the Internet and the plurality of clients view the information related to the plurality of independent components with a web browser.

38. A system for providing functional magnetic resonance imaging data comparison services, comprising:
a means for receiving from a client via a communications network a client data set containing information related to a functional magnetic resonance image;
a means for identifying a plurality of spatially independent components related to the client data set by applying a blind source separation algorithm to the client data set; and
a means for receiving from the client a request to compare the plurality of independent components to a set of fundamental independent components in a database, the set of fundamental independent components comprising common components which exist in a scientifically-significant portion of a plurality of sets of independent components corresponding to a plurality of functional magnetic resonance image data sets contained in the database.

39. The system of claim 38, further comprising a means for comparing the plurality of independent components related to the client data set to the set of fundamental independent components in the database.

40. The system of claim 39, further comprising a means for delivering to the client information based on the comparison via the communications network.

41. The system of claim 38, further comprising a means for reducing the dimensionality of the client data set by applying a singular value decomposition algorithm to the client data set prior to identifying spatially independent components of the client data set.

42. The system of claim 40, further comprising a means for charging the client for delivering the information based on the comparison.

43. The system of claim 40, wherein the communications network is the Internet and the client views the information with a web browser.

44. The system of claim 39, wherein the set of fundamental independent components in the database is modified based on the plurality of independent components related to the client data set.

45. A system for providing functional magnetic resonance imaging data analysis services, comprising:
an interface adapted to receive from a client via a communications network a data set containing information related to a functional magnetic resonance image of an individual's brain and adapted to deliver to the client information related to a plurality of spatially independent components related to the data set; and
a processing engine programmed to identify a plurality of spatially independent components related to the data set by applying a blind source separation algorithm to the data set.

46. The system of claim 45, wherein the processing engine is further programmed to reduce the dimensionality of the data set by applying a singular value decomposition algorithm to the data set prior to identifying a plurality of spatially independent components.

47. The system of claim 46, further comprising a billing functionality coupled to the interface for charging the client for delivering the independent components of the data set.

48. The system of claim 46, wherein the communications network is the Internet and the interface is a web server.

49. The system of claim 46, further comprising a database for storing the plurality of independent components.

50. The system of claim 46, wherein the interface is further adapted to receive a request from the client via the communications network to compare the plurality of independent components to information related to a plurality of sets of other independent components stored in the database, each set of other independent components corresponding to another data set related to a distinct functional magnetic resonance image.

51. The system of claim 50, wherein the processing engine is further programmed to compare the plurality of independent components to the plurality of sets of independent components in the database and the interface is further adapted to deliver to the client via the communications network information based on the comparison.

52. The system of claim 51, further comprising a billing functionality coupled to the interface for charging the client for delivering the information based on the comparison.

53. A system for providing functional magnetic resonance imaging data analysis and comparison services, comprising:
an interface adapted to receive from a client via a communications network a client data set containing information related to a functional magnetic resonance image;
a processing engine programmed to identify a plurality of spatially independent components related to the client data set by applying a blind source separation algorithm to the client data set; and
a searchable database containing information related to (i) a plurality of sets of independent components corresponding to a plurality of functional magnetic resonance image data sets and (ii) a set of fundamental independent components comprising common independent components which exist in a scientifically-significant portion of the plurality of sets of independent components.

54. The system of claim 53, further comprising a functional magnetic resonance image comparison engine programmed to compare the plurality of independent components related to the client data set to the set of fundamental independent components in the database.

55. The system of claim 54, wherein the interface is coupled to the comparison engine and is adapted to deliver to the client information based on the comparison via the communications network.

56. The system of claim 53, wherein the processing engine is further programmed to reduce the dimensionality of the client data set by applying a singular value decomposition algorithm to the client data set prior to identifying spatially independent components of the client data set.

57. The system of claim 55, further comprising a billing functionality coupled to the interface for charging the client for delivering the information based on the comparison.

58. The system of claim 55, wherein the communications network is the Internet and the interface is a web server.

59. The system of claim 53, wherein the set of fundamental independent components in the database is modified based on the plurality of independent components related to the client data set.

60. A computer-readable medium for use by a computer for providing functional magnetic resonance imaging data analysis services, comprising:
a first portion of code for receiving from a client via a communications network a data set containing information related to a functional magnetic resonance image of an individual's brain;
a second portion of code for identifying a plurality of spatially independent components related to the data set by applying a blind source separation algorithm to the data set; and
a third portion of code for delivering to the client via a communications network information related to the plurality of independent components of the data set.

61. The computer-readable medium of claim 60, further comprising a fourth portion of code for reducing the dimensionality of the data set by applying a singular value decomposition algorithm to the data set prior to identifying spatially independent components of the data set.

62. The computer-readable medium of claim 60, further comprising a fourth portion of code for charging the client for delivering the independent components of the data set.

63. The computer-readable medium of claim 60, wherein receiving from the client and delivering to the client is via the Internet and the client views the information related to the plurality of independent components of the data set with a web browser.

64. The computer-readable medium of claim 60, further comprising a fourth portion of code for storing the plurality of independent components in a database containing information related to a plurality of sets of other independent components, each set of other independent components corresponding to another data set related to a distinct functional magnetic resonance image of another individual's brain.

65. The method of claim 60, further comprising a fourth portion of code for receiving a request from the client via the communications network to compare the plurality of independent components to the plurality of sets of other independent components in the database.

66. The computer-readable medium of claim 65, further comprising a fifth portion of code for (i) comparing the plurality of independent components to the plurality of sets of independent components in the database and (ii) delivering to the client via the communications network information based on the comparison.

67. The computer-readable medium of claim 66, further comprising a sixth portion of code for charging the client for delivering the information based on the comparison.

68. A computer-readable medium for use by a computer for providing functional magnetic resonance imaging comparison services, comprising:
a first portion of code for receiving from a client via a communications network a client data set containing information related to a functional magnetic resonance image;
a second portion of code for identifying a plurality of spatially independent components related to the client data set by applying a blind source separation algorithm to the client data set; and
a third portion of code for receiving from the client a request to compare the plurality of independent components to a set of fundamental independent components in a database, the set of fundamental independent components comprising common components which exist in a scientifically-significant portion of a plurality of sets of independent components corresponding to a plurality of functional magnetic resonance image data sets contained in the database.

69. The computer-readable medium of claim 68, further comprising a fourth portion of code for comparing the plurality of independent components related to the client data set to the set of fundamental independent components in the database.

70. The computer-readable medium of claim 69, further comprising a fifth portion of code for delivering to the client information based on the comparison via the communications network.

71. The computer-readable medium of claim 68, further comprising a fourth portion of code for reducing the dimensionality of the client data set by applying a singular value decomposition algorithm to the client data set prior to identifying spatially independent components of the client data set.

72. The method of claim 70, further comprising a sixth portion of code for charging the client for delivering the information based on the comparison.

73. The computer-readable medium of claim 70, wherein receiving from a client and delivering to the client is via the Internet and the client views the information with a web browser.

74. The computer-readable medium of claim 69, further comprising a fifth portion of code for modifying the set of fundamental independent components in the database based on the plurality of independent components related to the client data set.
